(19) United States
(12) Patent Application Publication
(10) Pub. No.: US 2017/0254909 A1
(43) Pub. Date: Sep. 7, 2017

(54) METHOD FOR DETERMINING MAXIMUM HORIZONTAL STRESS MAGNITUDE AND DIRECTION USING MICROSEISMIC DERIVED FRACTURE ATTRIBUTES AND ITS APPLICATION TO EVALUATING HYDRAULIC FRACTURE STIMULATION INDUCED STRESS CHANGES

(71) Applicant: Microseismic, Inc., Houston, TX (US)

(72) Inventor: Alireza Agharazi, Houston, TX (US)

(21) Appl. No.: 15/445,440

(22) Filed: Feb. 28, 2017

Related U.S. Application Data
(60) Provisional application No. 62/302,295, filed on Mar. 2, 2016.

(51) Int. Cl. G01V 1/28; E21B 43/26; E21B 49/00

(52) U.S. Cl. CPC G01V 1/288; E21B 49/00; E21B 43/26; G01V 2210/1234; G01V 2210/624; E21B 43/267

(57) ABSTRACT

A method for determining maximum horizontal stress in a subsurface formation includes using recordings of seismic energy detected proximate the subsurface formation to determine hypocenters of microseismic events. A focal mechanism for each microseismic event is determined. A measurement corresponding to vertical stress magnitude at a depth of the subsurface formation is used to normalize horizontal stress magnitudes for formation depth. The focal mechanism is used to determine a maximum horizontal stress direction. A measurement corresponding to a depth normalized minimum horizontal stress magnitude and the focal mechanism are used to determine a depth normalized maximum horizontal stress magnitude.

### CROSS REFERENCE TO RELATED APPLICATIONS

Priority is claimed from U.S. Provisional Application No. 62/302,295 filed on Mar. 2, 2016.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of passive seismic evaluation of subsurface formations. More specifically, the disclosure relates to methods for determining subsurface stress fields from seismic events occurring in the subsurface and application of such methods to determining changes in the stress fields and pressures induced by activities such as hydraulic fracturing.

Passive seismic evaluation of subsurface formations is used for, among other purposes, determining the origin time and spatial position of microearthquakes (referred to as “microseismic events”) occurring in the subsurface. Example embodiments of methods for passive seismic evaluation are described in U.S. Pat. No. 7,663,970 issued to Duncan et al. and U.S. Pat. No. 8,960,280 issued to McKenna et al.

In general passive seismic methods as described in the above cited patents include deploying a plurality of seismic sensors above a volume of the Earth's subsurface to be evaluated, and recording detected seismic signals for a selected length of time. The recorded signals may be processed to determine the origin time and the spatial position (hypocenter) of each seismic event (typically a fracture) that occurs in the subsurface. Determining hypocenters, e.g., during pumping of an hydraulic fracture treatment may enable determining the movement of the fracturing fluid with respect to time. Fracture plane orientation of fractures induced by the hydraulic fracturing may also be determined.

It is useful for the purposes of design of hydraulic fracture treatments, among other uses, to have some understanding of the subsurface stresses imparted to the formations in a particular geologic area. The present disclosure is related to methods for evaluating the stress magnitudes and directions using passive seismic signals.

The in-situ stress parameters, i.e. the magnitude and direction of three principal stresses, are key inputs in the design of hydraulic fracturing treatments in unconventional reservoirs. It is well understood and widely accepted that when injecting hydraulic fracturing fluid into a horizontal well, an induced vertical hydraulic fracture propagates in the direction of the maximum horizontal stress (SHmax), which is the least resistant path to fracture growth. The lineaments of microseismic events can be used to identify the general trend of fracture propagation and thereby obtain a rough estimate of the SHmax direction. However, this method is dependent on observed judgment and does not provide an accurate estimate of the SHmax direction. Neither does it provide any information on the magnitude of SHmax.

The minimum fracture treatment pressure is a function of stress magnitudes, and more specifically minimum horizontal stress Shmin. Higher stresses require more fracturing apparatus pump horsepower. Numerical studies along with microseismic observations indicate that the difference between the magnitudes of horizontal stresses, i.e. stress anisotropy, has a considerable impact on the final fracture stimulation pattern, and should be considered when designing the treatment parameters such as stage length and fracturing fluid composition. While density logs and well tests, such as DFIT and mini-frac tests, are routinely used to estimate the magnitudes of vertical stress and minimum horizontal stress, respectively, there is no direct means available to measure the magnitude of maximum horizontal stress at the fracture treatment depth. It is thus desirable to develop methods to accurately estimate the direction and magnitude of the field maximum horizontal stress using data collected during drilling and completion of the treatment well.

The creation of hydraulic fractures changes the stresses within the treatment area. When the fluid pressure inside the hydraulic fracture exceeds the field stress component acting normal to the fracture plane, the fracture starts to dilate and gain width. As the fracture dilates it compresses the rock on either side of the fracture, giving rise to the increase of compressive stress in the direction normal to the fracture plane. For transverse fractures initiated from horizontal wells, this direction is parallel to the direction of regional minimum horizontal stress (SHmin).

An estimation of the induced fracture geometry and proppant placement pattern can be obtained by mapping the changes in the magnitude of minimum horizontal stress after the treatment. There is, however, no direct or indirect method to monitor and measure the stimulation-induced stress changes during or after the treatment. It is thus beneficial to develop new methods to estimate and map the stress changes along the well after completion of the well.

### BRIEF DESCRIPTION OF THE DRAWINGS

FIG. 1 shows an example arrangement of seismic sensors as they would be used in one application of a method according to the present disclosure.

FIG. 2 shows a flow chart of an example embodiment of a method according to the present disclosure.

FIG. 3A shows a plan view map of microseismic event positions.

FIG. 3B shows a map as in FIG. 3A with SHmin distributions plotted.

FIG. 3C shows a map as in FIG. 3B with pressure normalized for vertical stress.

FIG. 4 shows an example computer system than may be used in some embodiments.

### DETAILED DESCRIPTION

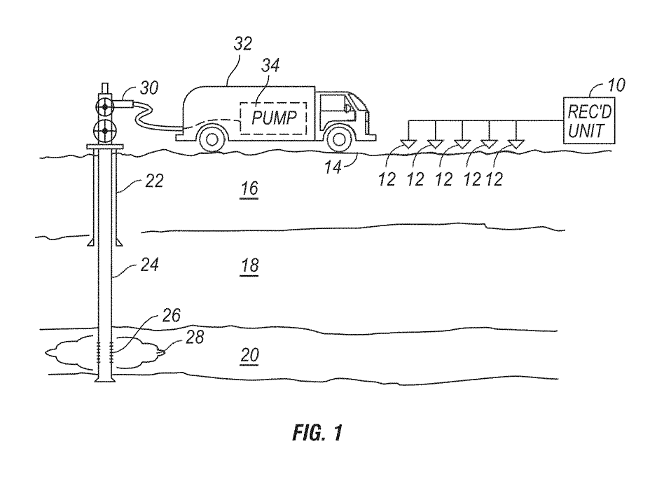

FIG. 1 shows an example arrangement of seismic sensors as they would be used in one example application of a method according to the present disclosure. The embodiment illustrated in FIG. 1 is associated with an application for passive seismic emission tomography known as “frac monitoring.” It should be clearly understood that the application illustrated in FIG. 1 is only one possible application of a method according to the invention.

In FIG. 1, each of a plurality of seismic sensors, shown generally at 12, is deployed at a selected position proximate the Earth's surface 14. In marine applications, the seismic sensors would typically be deployed on the water bottom in a device known as an “ocean bottom cable.” The seismic sensors 12 in the present embodiment may be geophones, but may also be accelerometers or any other sensing device known in the art that is responsive to velocity, acceleration or motion of the particles of the Earth proximate the sensor. The seismic sensors 12 generate electrical or optical signals in response to the particle motion or acceleration, and such signals are ultimately coupled to a recording unit 10 for making a time-indexed recording of the signals from each sensor 12 for later interpretation by a method according to the invention. In other implementations, the seismic sensors 12 may be disposed at various positions within a wellbore drilled through the subsurface formations. A particular advantage of the method of the invention is that it provides generally useful results when the seismic sensors are disposed at or near the Earth's surface. Surface deployment of seismic sensors is relatively cost and time effective as contrasted with subsurface sensor emplacements typically needed in methods known in the art prior to the present invention.

In some embodiments, the seismic sensors 12 may be arranged in sub-groups having spacing therebetween less than about one-half the expected wavelength of seismic energy from the Earth's subsurface that is intended to be detected. Signals from all the sensors in one or more of the sub-groups may be added or summed to reduce the effects of noise in the detected signals.

In other embodiments, the seismic sensors 12 may be placed in a wellbore, either permanently for certain long-term monitoring applications, or temporarily, such as by wireline conveyance, tubing conveyance or any other sensor conveyance technique known in the art.

A wellbore 22 is shown drilled through various subsurface Earth formations 16, 18, through a hydrocarbon producing formation 20. A wellbore tubing 24 having perforations 26 formed therein corresponding to the depth of the hydrocarbon producing formation 20 is connected to a valve set known as a wellhead 30 disposed at the Earth's surface. The wellhead may be hydraulically connected to a pump 34 in a frac pumping unit 32. The frac pumping unit 32 is used in the process of pumping a fluid, which in some instances includes selected size solid particles, collectively called “proppant”, are disposed. Pumping such fluid, whether propped or otherwise, is known as hydraulic fracturing. The movement of the fluid is shown schematically at the fluid front 28 in FIG. 1. In hydraulic fracturing techniques known in the art, the fluid is pumped at a pressure which exceeds the fracture pressure of the particular producing formation 20, causing it to rupture, and form fissures therein. The fracture pressure is generally related to the pressure exerted by the weight of all the formations 16, 18 disposed above the hydrocarbon producing formation 20, and such pressure is generally referred to as the “overburden pressure.” In propped fracturing operations, the particles of the proppant move into such fissures and remain therein after the fluid pressure is reduced below the fracture pressure of the formation 20. The proppant, by appropriate selection of particle size distribution and shape, forms a high permeability channel in the formation 20 that may extend a great lateral distance away from the tubing 24, and such channel remains permeable after the fluid pressure is relieved. The effect of the proppant filled channel is to increase the effective radius of the wellbore 24 that is in hydraulic communication with the producing formation 20, thus substantially increasing productive capacity of the wellbore 24 to hydrocarbons.

The fracturing of the formation 20 by the fluid pressure creates seismic energy that is detected by the seismic sensors 12. The time at which the seismic energy is detected by each of the sensors 12 with respect to the time-dependent position in the subsurface of the formation fracture caused at the fluid front 28 is related to the acoustic velocity of each of the formations 16, 18, 20, and the position of each of the seismic sensors 12.

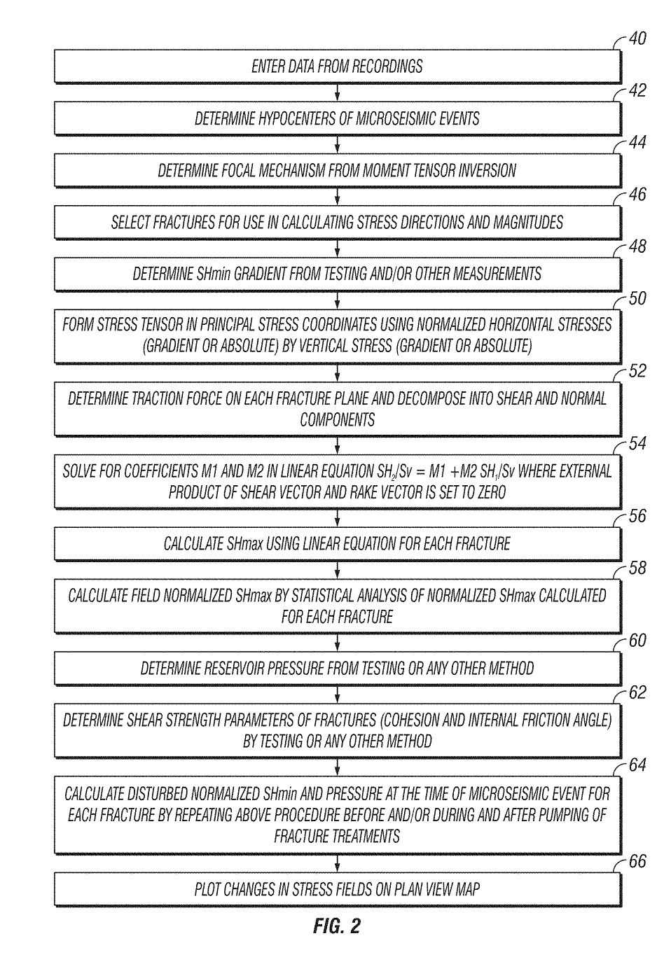

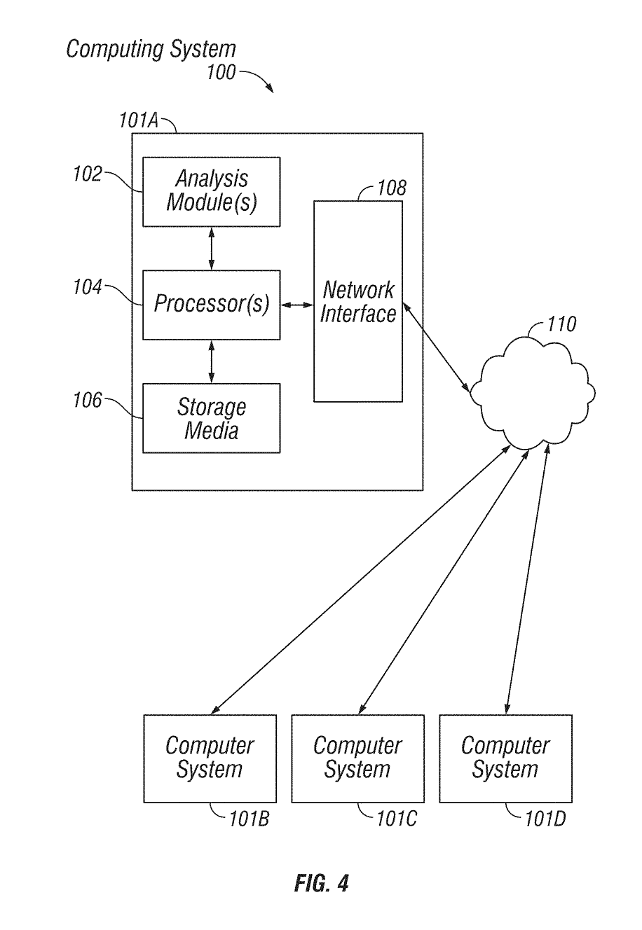

Having explained one type of passive seismic data that may be used with methods according to the present disclosure, methods for processing such seismic data will now be explained. Referring to FIG. 2, the seismic signals recorded from each of the sensors 12 may be entered, at 40, into a processor or general purpose computer or computer system (FIG. 4) and processed first by certain procedures well known in the art of seismic data processing, including the summing described above, and various forms of filtering. In some embodiments, the sensors (12 in FIG. 1) may be arranged in directions substantially along a direction of propagation of acoustic energy that may be generated by the pumping unit (32 in FIG. 1), in the embodiment of FIG. 1 radially outward away from the wellhead (30 in FIG. 1). By such arrangement of the seismic sensors, noise from the pumping unit and similar sources near the wellhead may be attenuated in the seismic signals by frequency-wavenumber (f k) filtering. Other processing techniques for noise reduction and/or signal enhancement will occur to those of ordinary skill in the art.

The hypocenter (origin time and spatial location of occurrence) of each seismic event, such as those induced by the foregoing hydraulic fracturing may be determined, at 42, using the above processed recordings of the signals detected by the seismic sensors (12 in FIG. 1). A non-limiting example of a method for determining hypocenters from passive seismic signals is described in U.S. Pat. No. 7,663,970 issued to Duncan et al. Other methods for determining hypocenters are known to those skilled in the art.

Once the hypocenters of the seismic events have been determined at 42, an example embodiment of a method according to the present disclosure may include the following actions.

First, a focal mechanism for each microseismic event may be determined, at 44. The focal mechanism may be determined, e.g., by moment tensor inversion. Parameters calculated as a result of determining the focal mechanism for each microseismic event include fracture plane geodetic orientation (“strike” and “dip” of the fracture plane), and movement of the subsurface formations in a direction along the fracture plane (“rake”). One embodiment of making such determinations from microseismic events is described in, M. L. Jost and R. B. Herrmann, A Student's Guide to and Review of Moment Tensors, Seismological Research Letters, Volume 60, No. 2, April-June, 1989.

The field stress tensor can be defined by six parameters. Three are the principal stress directions, i.e., maximum horizontal stress, minimum horizontal stress and vertical stress. The other three parameters are the magnitudes of each of the three principal stresses. Using the geodetic orientation of each fracture determined as explained above, microseismic events (fractures) may be identified, at 46, that are not vertically oriented and for which the motion of the formations along the fracture is along the dip direction of the fracture plane. Such microseismic events may be used to determine the direction of the maximum or minimum horizontal stresses (SHmax, SHmin). The strike of the above identified fractures is parallel to the direction of SHmax or SHmin. Considering the general trend of microseismic events, and other evidences, the direction of SHmax can be identified from the above direction.

For a plurality of microseismic events, in one embodiment the directions SHmax of each of the identified microseismic events may be averaged if and as necessary. In some embodiments directional outliers may be excluded from the average, wherein outliers may be determined using, for example and without limitation, a method such as that disclosed in the McKenna et al. '280 patent referred to in the Background section herein. Other stress magnitudes and directions may be determined by assuming that the vertical stress is in a direction parallel to Earth's gravity (i.e., vertical). A magnitude of the vertical stress may be calculated using data including, without limitation, wellbore formation density logs, wellbore gravity logs and surface gravity measurements to estimate the overburden to the depth of a formation of interest (e.g., the formation being fracture treated).

The direction of minimum horizontal stress SHmin is orthogonal to the direction of maximum horizontal stress, SHmax, determined as explained above. The magnitude of SHmin may be calculated, at 48, for example and without limitation from mini-fracture test (formation pumping breakdown test). The magnitude of SHmax may then be calculated as the remaining parameter of the six parameters where the others have been determined as explained above using the following technique. Calculation of the magnitude of SHmax may be performed as follows.

Ratios of maximum and minimum horizontal stress magnitudes to the vertical stress may be calculated to normalize the calculated stresses for the vertical depth of the microseismic events. By using the strike and dip of each fracture, determined as explained above, a normal vector to the fracture plane may be calculated for each microseismic event. A traction force on each fracture plane may be calculated. The traction force may be decomposed into shear and normal components. The foregoing may be explained as follows. First, form a stress tensor, at 50, in the coordinate system of the principal stresses (assuming vertical stress and maximum and minimum horizontal stress directions determined as explained above. The stress tensor may be expressed as:

$${σ}_{ij} = [ \begin{matrix}{σ}_{11} & 0 & 0 \\ 0 & {σ}_{22} & 0 \\ 0 & 0 & {σ}_{33}\end{matrix} ] = [ \begin{matrix}{SH}_{1} & 0 & 0 \\ 0 & {SH}_{2} & 0 \\ 0 & 0 & Sv\end{matrix} ] = Sv [ \begin{matrix}{SR}_{H 1} & 0 & 0 \\ 0 & {SR}_{H 2} & 0 \\ 0 & 0 & 1\end{matrix} ]$$

where SR_{H1} and SR_{H2}, represent two horizontal stresses normalized by the vertical stress.

Next, form a unit normal vector (n) to the fracture planes based on the fracture strike and dip. The traction (T) acting on each fracture may be calculated as: Tᵢ=σᵢⱼnⱼ at 52 in FIG. 2. The shear component (vector Ts) of the traction vector on the fracture plane may then be calculated. The rake vector in reference coordinate system (R) may then be determined based on the rake angle and strike calculated, e.g., by the moment tensor inversion technique as described above. The governing equation for each fracture is Ts×R=0. Values of coefficients M1 and M2 of a linear equation relating the depth normalized SH₁ and SH₂ may be determined such that an external product of the above shear vector and rake vector may be set to zero, at 54. The foregoing may be represented by the following linear expression:

SH₁/Sv=M1+M2 SH₂/Sv (1)

Using Eq. (1) and the normalized SHmin determined as explained above, the normalized maximum horizontal stress magnitude SHmax may be calculated, at 56 using the above matrix. Using the determined value of normalized SHmax, it is then possible to calculate an undisturbed field maximum horizontal stress magnitude at 58. This stress may be used as input for hydraulic fracture simulation, geomechanical modeling and any other applications such as reservoir simulation

Using the calculated undisturbed normalized SHmax and SHmin, the disturbed SHmin due to fracture inflation, can be calculated for the events that are not consistent with the determined initial field stress regime.

The fluid pressure at failure can be calculated or measured, at 60, for each fracture using the calculated current state of stress at each fracture and shear strength parameters of the fracture plane. This can be used as a diagnostic tool to track the extent of pressure perturbations around the treatment zone and explain the potential local high frequency of microseismic events. An example implementation may include the following:

1. Use input from the above described method to determine in situ undisturbed stress field at 62.

2. Generate a plan view map of well path mapped onto stress field direction.

3. Calculate changes in SHmin/SV at 64. Use the same equation (1) for each event. The foregoing be done during or after pumping of fractures. Use the results to map stress and pressure changes in disturbed rock at 66.

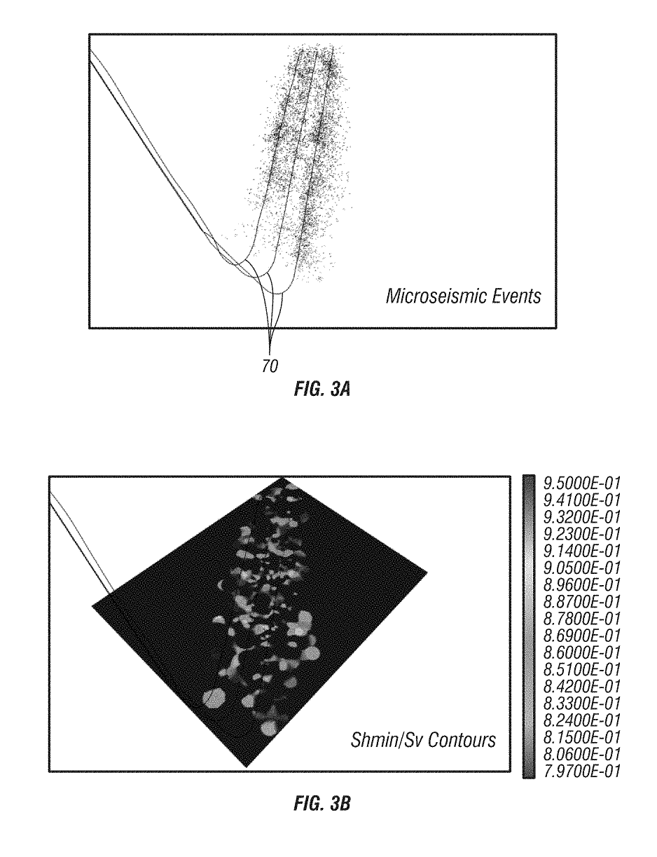

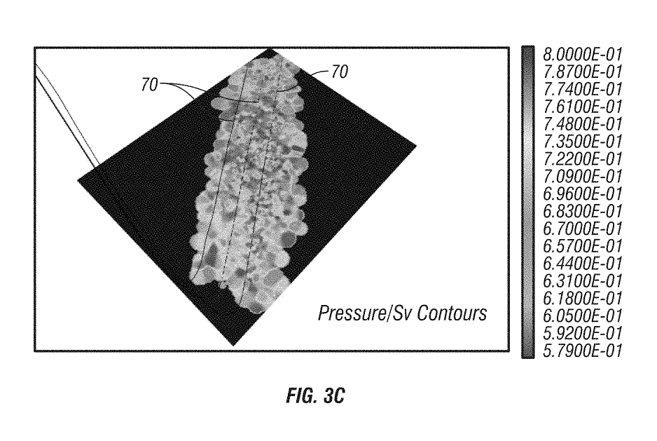

4. Adjust the inputs to geomechanical model and/or fracture treatment parameters and the foregoing procedure may be repeated. The foregoing is shown in FIGS. 3A and 3B/3C, wherein three lateral wellbores 70 drilled through a formation that is fracture treated are shown respectively as to the positions of origin of microseismic events (FIG. 3A) and a distribution of the depth normalized SHmin and pressure during treatment (at the time of microseismic event) (FIG. 3B/3C).

The injection of fracturing fluid increases the hydraulic pressure on natural fractures which reduces effective normal stress on fracture planes and triggers shear failure of fractures. The fracture pressure at failure can be determined for each fracture based on the current state of stress on each fracture (calculated as described above) and knowing shear strength parameters of fractures.

A map of the stimulation induced pressure changes can be produced by plotting the estimated pressure for each fracture along the treatment. The plot in FIG. 3C shows the variation of microseismic activity with induced pressure.

FIG. 4 shows an example computing system 100 in accordance with some embodiments. The computing system 100 may be an individual computer system 101A or an arrangement of distributed computer systems. The individual computer system 101A may include one or more analysis modules 102 that may be configured to perform various tasks according to some embodiments, such as the tasks explained with reference to FIG. 2. To perform these various tasks, the analysis module 102 may operate independently or in coordination with one or more processors 104, which may be connected to one or more storage media 106. A display device 105 such as a graphic user interface of any known type may be in signal communication with the processor 104 to enable user entry of commands and/or data and to display results of execution of a set of instructions according to the present disclosure.

The processor(s) 104 may also be connected to a network interface 108 to allow the individual computer system 101A to communicate over a data network 110 with one or more additional individual computer systems and/or computing systems, such as 101B, 101C, and/or 101D (note that computer systems 101B, 101C and/or 101D may or may not share the same architecture as computer system 101A, and may be located in different physical locations, for example, computer systems 101A may be at a well location, e.g., in the recording unit (10 in FIG. 1) while in communication with one or more computer systems such as 101B, 101C and/or 101D that may be located in one or more data centers on shore, aboard ships, and/or located in varying countries on different continents).

A processor may include, without limitation, a microprocessor, microcontroller, processor module or subsystem, programmable integrated circuit, programmable gate array, or another control or computing device.

The storage media 106 may be implemented as one or more computer-readable or machine-readable storage media. Note that while in the example embodiment of FIG. 4 the storage media 106 are shown as being disposed within the individual computer system 101A, in some embodiments, the storage media 106 may be distributed within and/or across multiple internal and/or external enclosures of the individual computing system 101A and/or additional computing systems, e.g., 101B, 101C, 101D. Storage media 106 may include, without limitation, one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that computer instructions to cause any individual computer system or a computing system to perform the tasks described above may be provided on one computer-readable or machine-readable storage medium, or may be provided on multiple computer-readable or machine-readable storage media distributed in a multiple component computing system having one or more nodes. Such computer-readable or machine-readable storage medium or media may be considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

It should be appreciated that computing system 100 is only one example of a computing system, and that any other embodiment of a computing system may have more or fewer components than shown, may combine additional components not shown in the example embodiment of FIG. 4, and/or the computing system 100 may have a different configuration or arrangement of the components shown in FIG. 4. The various components shown in FIG. 4 may be implemented in hardware, software, or a combination of both hardware and software, including one or more signal processing and/or application specific integrated circuits.

Further, the acts of the processing methods described above may be implemented by running one or more functional modules in information processing apparatus such as general purpose processors or application specific chips, such as ASICs, FPGAs, PLDs, or other appropriate devices. These modules, combinations of these modules, and/or their combination with general hardware are all included within the scope of the present disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for determining maximum horizontal stress magnitude and direction in a subsurface formation, comprising:
entering into a computer recordings of seismic energy detected proximate the subsurface formation;
in the computer, determining hypocenters of microseismic events from the recordings;
in the computer, determining a focal mechanism for each microseismic event;
entering into the computer a measurement corresponding to vertical stress magnitude at a depth of the subsurface formation;
in the computer, using the focal mechanism to determine a maximum horizontal stress direction;
entering into the computer a measurement corresponding to a depth normalized minimum horizontal stress magnitude; and
in the computer, determining a depth normalized maximum horizontal stress magnitude using the focal mechanism and the depth normalized minimum horizontal stress magnitude.

2. The method of claim 1 wherein the focal mechanism comprises a strike, a dip and a rake.

3. The method of claim 2 wherein the focal mechanism is determined by moment tensor inversion.

4. The method of claim 1 wherein the depth normalized maximum horizontal stress magnitude is determined from the depth normalized minimum horizontal stress magnitude and a solution to a relationship between the depth normalized maximum horizontal stress magnitude and the depth normalized minimum horizontal stress magnitude wherein an external product of a shear component of a traction vector and a rake vector of each microseismic event is equal to zero.

5. The method of claim 4 wherein the relationship is linear.

6. The method of claim 1 wherein the strike of each microseismic event is used in the computer to determine the maximum horizontal stress direction.

7. The method of claim 6 wherein a field maximum stress direction is determined by averaging the strike of all microseismic events.

8. The method of claim 6 wherein microseismic events having vertical dip or wherein motion of the subsurface formation is not along the dip direction of a fracture plane are excluded from the determining the maximum horizontal stress direction.

9. The method of claim 1 wherein the measurement corresponding to vertical stress comprises at least one of wellbore density measurements, wellbore gravity measurements and surface gravity measurements.

10. The method of claim 1 wherein the measurement corresponding to depth normalized minimum horizontal stress magnitude comprises measurement of a formation fluid breakdown pressure.

11. The method of claim 1 further comprising, in the computer, repeating the determining depth normalized maximum and minimum horizontal stress magnitudes during pumping of hydraulic fracture fluid into the subsurface formation, and adjusting inputs to a geomechanical model and/or fracture treatment parameters based on changes in the depth normalized maximum and minimum horizontal stress magnitudes.

12. A method for determining maximum horizontal stress magnitude and direction in a subsurface formation, comprising:
pumping an hydraulic fracturing fluid into the subsurface formations;
detecting seismic energy in a plurality of seismic sensors disposed in a selected pattern proximate the subsurface formation
entering into a computer recordings of the seismic energy detected proximate the sub surface formation;
in the computer, determining hypocenters of microseismic events from the recordings;
in the computer, determining a focal mechanism for each microseismic event;
entering into the computer a measurement corresponding to vertical stress magnitude at a depth of the subsurface formation;
in the computer, using the focal mechanism to determine a maximum horizontal stress direction;
entering into the computer a measurement corresponding to a depth normalized minimum horizontal stress magnitude;
in the computer, determining a depth normalized maximum horizontal stress magnitude using the focal mechanism and the depth normalized minimum horizontal stress magnitude; and
at least one of displaying and recording the determined depth normalized maximum horizontal stress.

13. The method of claim 12 wherein the focal mechanism comprises a strike, a dip and a rake.

14. The method of claim 13 wherein the focal mechanism is determined by moment tensor inversion.

15. The method of claim 12 wherein the depth normalized maximum horizontal stress magnitude is determined from the depth normalized minimum horizontal stress magnitude and a solution to a relationship between the depth normalized maximum horizontal stress magnitude and the depth normalized minimum horizontal stress magnitude wherein an external product of a shear component of a traction vector and a rake vector of each microseismic event is equal to zero.

16. The method of claim 15 wherein the relationship is linear.

17. The method of claim 12 wherein the strike of each microseismic event is used in the computer to determine the maximum horizontal stress direction.

18. The method of claim 17 wherein a field maximum stress direction is determined by averaging the strike of all microseismic events.

19. The method of claim 17 wherein microseismic events having vertical dip or wherein motion of the subsurface formation is not along the dip direction of a fracture plane are excluded from the determining the maximum horizontal stress direction.

20. The method of claim 12 wherein the measurement corresponding to vertical stress comprises at least one of wellbore density measurements, wellbore gravity measurements and surface gravity measurements.

21. The method of claim 12 wherein the measurement corresponding to depth normalized minimum horizontal stress magnitude comprises measurement of a formation fluid breakdown pressure.

22. The method of claim 12 further comprising, in the computer, repeating the determining depth normalized maximum and minimum horizontal stress magnitudes during pumping of hydraulic fracture fluid into the subsurface formation, and adjusting inputs to a geomechanical model and/or fracture treatment parameters based on changes in the depth normalized maximum and minimum horizontal stress magnitudes.
